(19) United States
(12) Patent Application Publication
(10) Pub. No.: US 2026/0314680 A1
(43) Pub. Date: Oct. 15, 2026

(54) AN AEROSOL-GENERATING DEVICE COMPRISING A CONTROLLER TO IDENTIFY A SUSCEPTOR

(71) Applicant: Philip Morris Products S.A., Neuchatel (CH)

(72) Inventor: Enrico STURA, Palézieux-Village (CH)

(73) Assignee: Philip Morris Products S.A., Neuchatel (CH)

(21) Appl. No.: 19/482,174

(22) PCT Filed: May 8, 2024
(86) PCT No.: PCT/EP2024/062807

§ 371 Date: Nov. 6, 2025

(30) Foreign Application Priority Data
May 12, 2023 (EP) 23173055.7

(51) Int. Cl. A24F 40/465; A24D 1/20; A24F 40/20; A24F 40/51; A24F 40/53

(52) U.S. Cl. CPC A24F 40/465; A24F 40/20; A24F 40/51; A24F 40/53; A24D 1/20

(57) ABSTRACT

An aerosol-generating system is provided, including: an aerosol-generating device for different aerosol-generating articles, each of the articles including an aerosol-forming substrate and a susceptor, each susceptor differing from the other susceptors in terms of shape, size, and/or material, the device including a cavity to receive one of the articles, an induction coil to heat the susceptor, and a controller to supply an electrical signal to the coil, identify an inductive response of the susceptor in reaction to the signal, differentiate between the articles based on the response to identify the article in the cavity, and identify a transient response that is the time-domain analysis of a measured output, and the electrical signal is not applied during measurement of the transient response; and one of the articles for the device, a shape, size, and/or material of the susceptor being configured to trigger the inductive response for identification at the device.

The present invention relates to an aerosol-generating device, an aerosol-generating article, an aerosol-generating system and a method for detecting an aerosol-generating article.

It is known to provide an aerosol-generating device for generating an inhalable vapor. Such devices may heat aerosol-forming substrate to a temperature at which one or more components of the aerosol-forming substrate are volatilised without burning the aerosol-forming substrate. The aerosol-forming substrate may be provided as part of an aerosol-generating article. The aerosol-generating article may have a rod shape for insertion of the aerosol-generating article into a cavity of the aerosol-generating device. The cavity of the aerosol-generating device may comprise a heating chamber. A heating element may be arranged in or around the heating chamber for heating the aerosol-forming substrate once the aerosol-generating article is inserted into the heating chamber of the aerosol-generating device. Aerosol-generating devices are typically designed to operate best when used with an original and specifically designed aerosol-generating article. Furthermore, manufacturers of aerosol-generating articles may offer a product line of an aerosol-generating article in a variety of types with different characteristics, such as flavor or nicotine content.

It would be desirable to provide an aerosol-generating device capable of identifying an aerosol-generating article. It would be desirable to provide an aerosol-generating device capable of identifying the presence of an authorized aerosol-generating article. It would be desirable to provide an aerosol-generating device capable of identifying an aerosol-generating article with enhanced reliability. It would be desirable to provide an aerosol-generating device with improved detection capabilities. It would be desirable to have an aerosol-generating device providing an optimized user experience. It would be desirable to have an aerosol-generating article enabling improved identification by an aerosol-generating device. It would be desirable to provide an aerosol-generating system capable of identifying an aerosol-generating article with minimum configurational changes to existing aerosol-generating articles and aerosol-generating devices.

According to another aspect, there is provided aerosol-generating device which may be for use with a plurality of different aerosol-generating articles. Each one of the plurality of different aerosol-generating articles may comprise an aerosol-forming substrate and/or a susceptor. Each susceptor of each one of the plurality of different aerosol-generating articles may differ from the other susceptors of the plurality of different aerosol-generating articles in terms of one or more of susceptor shape, susceptor size and susceptor material. The aerosol-generating device may comprise a cavity configured for receiving one of the plurality of different aerosol-generating articles. The aerosol-generating device may comprise an induction coil for heating the susceptor. The aerosol-generating device may comprise a controller. The controller may be configured for supplying an electrical signal to the induction coil. The controller may be configured for identifying an inductive response of the susceptor in reaction to the supply of the electrical signal. The controller may be configured for differentiating between the plurality of different aerosol-generating articles based on the susceptor shape, susceptor size and susceptor material in order to identify the aerosol-generating article received in the cavity. One or more of the susceptor shape, susceptor size and susceptor material may influence the inductive response of the susceptor. Hence, in other words, the controller may be configured for differentiating between the plurality of different aerosol-generating articles based on the inductive response in order to identify the aerosol-generating article received in the cavity. The inductive response may be monitored by the aerosol-generating device by monitoring the current drawn by the induction coil. The current drawn by the induction coil may be indicative of the inductive response, which in turn may be a function of the conductivity over time of the susceptor, which may be influenced/determined by one or more of the susceptor shape, susceptor size and susceptor material. It should be noted that in a particularly preferred embodiment, the controller may be configured for differentiating between the plurality of different aerosol-generating articles based on the susceptor shape and susceptor size in order to identify the aerosol-generating article received in the cavity.

According to an aspect of the invention, there is provided an aerosol-generating device for use with a plurality of different aerosol-generating articles, wherein each one of the plurality of different aerosol-generating articles comprises an aerosol-forming substrate and a susceptor. Each susceptor of each one of the plurality of different aerosol-generating articles differs from the other susceptors of the plurality of different aerosol-generating articles in terms of one or more of susceptor shape, susceptor size and susceptor material. The aerosol-generating device comprises: a cavity configured for receiving one of the plurality of different aerosol-generating articles, an induction coil for heating the susceptor and a controller. The controller is configured for supplying an electrical signal to the induction coil. The controller is configured for identifying an inductive response of the susceptor in reaction to the supply of the electrical signal. The controller is configured for differentiating between the plurality of different aerosol-generating articles based on the susceptor shape, susceptor size and susceptor material in order to identify the aerosol-generating article received in the cavity.

According to another aspect, there is provided an aerosol-generating device. The aerosol-generating device may comprise a cavity. The cavity may be configured for receiving an aerosol-generating article comprising an aerosol-forming substrate. The aerosol-forming substrate may comprise a susceptor. The aerosol-generating device may comprise an induction coil for heating the susceptor. The aerosol-generating device may comprise a controller. The controller may be configured for supplying an electrical signal to the induction coil. The controller may be configured for identifying an inductive response of the susceptor in reaction to the supply of the electrical signal.

It will be appreciated that identifying the aerosol-generating article for use with the aerosol-generating device may be useful for a variety of different purposes, and the invention is not limited to any one particular purpose for identifying the aerosol-generating article. For instance, identifying the aerosol-generating article may allow one of a plurality of predetermined heating profiles to be applied that is associated with the identified aerosol-generating article; identifying the aerosol-generating article may allow a user interface of the aerosol-generating device to operate differently in response to identifying the aerosol-generating article, e.g. by displaying a flavour of the aerosol-generating article; and/or identifying the aerosol-generating article may allow a record of consumption of each type of aerosol-generating article used with the aerosol-generating device to be stored at the aerosol-generating device to assist the user in monitoring their usage habits.

The invention may provide means and a method to detect and identify authorized aerosol-generating articles and types of aerosol-generating articles received in the aerosol-generating device. The article may be provided with a marker, preferably a susceptor. The device may be provided with a complementary article detector detecting the inductive response of the susceptor. A sensing element may be the article detector. The characteristics of the inductive response of the susceptor may be governed by the characteristics of the susceptor. The inductive response of the susceptor may generate a susceptor specific sensing element output. The device may be provided with a controller monitoring and processing the inductive response of the susceptor. By comparing the inductive response of the susceptor with pre-stored reference data, the controller may one or more of: (i) identify the presence an authorized article in the device, (ii) identify the type of the inserted article, (iii) regulate operation of the device in dependence on the characteristics of the inserted article, and (iv) determine the presence and/or absence of an article in the device.

Authorized articles may be provided with a susceptor or series of susceptors. In response to the identification of the presence of the authorized article, the controller may enable one or both of operation of the device and provision of a user experience. For example, power may be provided to a heating assembly of the aerosol-generating device. If the device does not identify the presence of an authorized article, the device may one or both of prevent operation of the device and provision of a user experience. For example, power being provided to the heating assembly may be prevented.

The invention may allow the provision of an optimized user experience by adapting aerosol generation to the configuration of a type of article inserted in the device. Articles belonging to a type of article may be provided with a type specific susceptor. By comparing the inductive response of the susceptor with pre-stored reference data, the device may identify the article type inserted in the device. In response, the device may adapt and thereby optimize aerosol generation. For example, a pre-stored article type specific heating profile may be employed. The type specific heating profile may correspond to a type specific configuration of aerosol-forming substrate within the article.

The inductive response of the susceptor may be tuned by varying one or both of the configuration and arrangement of the susceptor. Multiple different susceptors may be provided. Each susceptor may trigger a specific inductive response of the susceptor. One or more different susceptors may be allocated to known authorized articles. Each of a series of different susceptors may be allocated to different article types.

A susceptor of the present invention may be tuned by varying one or more of size (including length, width and depth), material and shape. The susceptor may be provided with one or more additional material layers. Two or more susceptors may be provided. A susceptor of given characteristics may be arranged in different orientations relative to a central longitudinal axis of the article. Variation in one of the discussed configurations and arrangements (size, material, shape, number, positions etc.) may be combined with the variation of one or more of another of such discussed configurations and arrangements to tune the interaction between the magnetic element and the article detector. Numerous different susceptors may be provided with ease and at low production cost.

Variation of one or more of the configuration and arrangement of the susceptor may tune the susceptor-intrinsic heat emission characteristics. Variations of the one or more configuration and arrangement of the susceptor may tune the surface temperature profile of the susceptor.

By varying of the configuration and arrangement of the susceptor, several effect may be achieved. Firstly, the presence of an authorized aerosol-generating article may be identified. Secondly, a type of aerosol-generating article may be identified. Thirdly, a specific heating action may be provided. The heating action may be optimized by one or more of (i) varying the configuration and arrangement of the susceptor leading to a particular spatial distribution of heat emitted by the susceptor, and (ii) providing an article type specific heating profile for heating the susceptor based on the identification of the article.

In use, the article comprising a susceptor may be inserted into the cavity of the device by a user. An electrical signal may be supplied to the induction coil. The electrical signal may inductively interact with the susceptor of the inserted article. The characteristics of the electrical signal may adapt to the presence of the susceptor. The characteristics of the electrical signal may adapt in dependence on the configuration and arrangement of the susceptor. The inductive response of the susceptor may be detected by a sensing element. The controller may be configured to monitor the inductive response of the susceptor. The controller may be configured to directly monitor the inductive response of the susceptor. The controller may be configured to monitor a signal based on the inductive response of the susceptor. The controller may be configured to monitor an output of the sensing element. The controller may correlate the monitored response or signal based on the response to pre-stored reference data to identify the inserted article. In response, the controller may adjust the operation of the device.

Herein, “electrical signal” may refer to an electromagnetic signal.

The invention may provide article detection and identification with one or more of an improved reliability and improved consistency. By reducing the risk of erroneous rejection of authorized articles, consumer satisfaction may be enhanced.

The invention may provide article detection and identification which can easily and cost-effectively be realized with existing articles and devices.

Identification of the presence of an authorized aerosol-generating article in the device may prevent or at least reduce the risk of usage of counterfeit and non-authorized articles with the device. Damage to the device may be avoided. Economic losses of authorized article manufacturers may be minimized.

Identification of a specific type of aerosol-generating article in the device may enable the provision of an optimized user experience. For example, an article type specific heating profile may be provided. Aerosol generation may be optimized and adapted according to the article type inserted in the device.

Detection of an aerosol-generating article using an inductive response of the susceptor may be realized with components requiring minimum space.

The detection of articles by an inductive response may avoid contact between the article and the article detector. The lifetime of the aerosol-generating device may be prolonged as friction between the article and the device may be prevented or at least reduced.

By providing susceptors of non-standard shapes, the risk of reproduction of the susceptors by unauthorized manufacturers may be reduced.

An “inductive response of the susceptor” may refer to the adaption of the electrical signal supplied to the induction coil in response to the presence of the susceptor. An “inductive response of the susceptor” may be a susceptor specific modification of the electrical signal of the induction coil, and as such may be referred to as an “inductive response signature”. An “inductive response of the susceptor” may refer to the difference between the electrical signal supplied to the induction coil in the absence of the article including the susceptor in the cavity and the electrical signal supplied to the induction coil in the presence of the article including the susceptor in the cavity.

The susceptor may inductively interact with the induction coil. The susceptor may inductively interact with the electrical signal supplied to the induction coil. The susceptor may inductively interact with the magnetic field of the electrical signal supplied to the induction coil. The electrical signal supplied to the induction coil may depend on the inductive interaction between the induction coil and the susceptor. The inductive interaction may depend on one or more of the size, material, shape, number and location of susceptor. The inductive response of the susceptor may depend on one or more of the size, material, shape, number and location of susceptor. The electrical signal supplied by the controller to the induction coil may depend on the susceptor. The electrical signal supplied by the controller to the induction coil may depend on one or more of the size, material, shape, number and location of susceptor. The electrical signal supplied by the controller to the induction coil may adapt in response to the susceptor. The electrical signal supplied may adapt in dependence on one or more of the size, material, shape, number and location of susceptor.

The electrical signal supplied to the induction coil may be an alternating electrical signal. The electrical signal supplied to the induction coil may be an alternating current. The electrical signal supplied to the induction coil may be an alternating current at constant voltage. The electrical signal supplied to the induction coil may be an alternating voltage. The value of the current may have a linear relation with the electrical property and the electrical conductance G of the susceptor. The electrical signal supplied to the induction coil may generate an alternating magnetic field in the cavity of the device.

The electrical signal may be configured to provide the power to provide a user experience. The electrical signal may be configured to heat the susceptor. The electrical signal may be configured to induce an eddy current in the susceptor. The electrical signal may be provided independently from the power to provide a user experience. The electrical signal may be provided in addition to the power to provide a user experience.

The electrical signal may be supplied during operation of the aerosol-generating device. The electrical signal may be provided prior to the operation of the aerosol-generating device. The electrical signal may be provided when the article is received in the cavity of the device.

The controller may be configured to supply a first electrical signal to the induction coil, which may be described as an identifying signal. This identifying signal may comprise a specific waveform for identifying one or more susceptors, e.g., one or more susceptors having different shapes and/or sizes. The waveform may be a sawtooth, sinusoidal, square, or triangular waveform. The frequency and/or amplitude of the identifying signal may vary with respect to time. For instance, the frequency may progressively increase or decrease with respect to time.

The controller may be configured to identify the inductive response of the susceptor in reaction to the supply of the identification signal. The controller may be configured to determine the type of aerosol-generating article from a plurality of aerosol-generating article types. The controller may be configured to apply a predetermined heating profile corresponding with the determined type of aerosol-generating article. The predetermined heating profile may be selected from a plurality of predetermined heating profiles.

The controller may be configured to supply a second electrical signal to the induction coil after applying the identification signal. The second electrical signal may be described as a heating signal. This heating signal differs from the identification signal at least in terms of its frequency and/or amplitude. In this way, the identification signal can be tailored to suit the task of identifying the aerosol-generating article, while the heating signal can be tailored to optimise heating.

The susceptor may be provided within the aerosol-forming substrate of the article. The susceptor may be embedded in the aerosol-forming substrate of the article. One or both of the configuration and the arrangement of the susceptor may be adapted to the configuration of the aerosol-generating article. One or more of the shape, material and size of the susceptor may be adapted to the configuration of the aerosol-generating article. One or more of the shape, material and size of the susceptor may be adapted to the configuration of the aerosol-forming substrate. The number of susceptors in the article may be adapted to the configuration of the aerosol-generating article. The distribution of a multitude of susceptors in the article may be adapted to the configuration of the aerosol-generating article. One or both configuration and the arrangement of the susceptor may be adapted in view of a specific spatial distribution of aerosol-forming substrate in the article. One or more of the shape, material and size of the susceptor may be adapted in view of a specific spatial distribution of aerosol-forming substrate in the article. The number of susceptors in the article may be adapted in view of a specific spatial distribution of aerosol-forming substrate in the article. The distribution of a multitude of susceptors in the article may be adapted in view of a specific spatial distribution of aerosol-forming substrate in the article.

The controller may be configured for identifying one or both of a transient response and a frequency response.

The transient response may be the response of a system to a change from an equilibrium or a steady state. A transient response may be a short-lived oscillation in a system caused by a sudden change of voltage, current or load. A transient response may be the time-domain analysis of the measured output obtained upon an know stimulus. The transient response may be measured after a stimulus (such as, the electrical signal) is applied. The stimulus may not be applied during measurement of the transient response.

The frequency response of a system may be a quantitative measure of how magnitude and phase of a measured signal vary with the input frequency. A frequency response may be the analysis of the behavior (reflected/absorbed signal) upon an input stimulus.

The electrical signal supplied to the induction coil may have a specific waveform. The waveform of the electrical signal supplied to the induction coil may be selected from one of a quadratic, noise, step and impulse waveform.

One or both of the transient response and the frequency response may be dependent on the susceptor. The inductive response of the susceptor may modify one or both of the transient response and the frequency response. The modification may be specific for a given susceptor of known configuration and arrangement.

Detection of one or both of the transient response and the frequency response may not require the sensing coil in addition to the induction coil. The transient response may be the transient response of the electrical signal supplied to induction coil in the presence of the of the susceptor. The frequency response may be the frequency response of the electrical signal supplied to the induction coil in the presence of the of the susceptor. The transient response may be detected by directly measuring the electrical signal supplied to the induction coil. The frequency response may be detected by directly measuring the electrical signal supplied to the induction coil. The measured transient response may be analyzed by the controller to identify the article. The measured frequency response may be analyzed by the controller to identify the article.

The aerosol-generating device may comprise a sensing element. Preferably the sensing element may comprise a sensing coil. The sensing element may be configured for detecting the inductive response of the susceptor in reaction to the supply of the electrical signal. The controller may be configured for identifying the inductive response of the susceptor in reaction to the supply of the electrical signal based on a sensing element output.

The sensing element may comprise a conductor. The sensing element may be configured for inductively interacting with the induction coil. The sensing element may be configured for inductively interacting with the electrical signal supplied to the induction coil. The electrical signal supplied to the induction coil may induce an electrical signal in the sensing coil. The electrical signal supplied to the induction coil may induce an electrical current in the sensing coil. The current induced in the sensing element may be indicative of the current of the electrical signal supplied to the induction coil. The current induced in the sensing element may be indicative of the response of the inductive response of the susceptor.

The electrical signal supplied to the induction element may generate an output of the sensing element. An output of the sensing element may be generated by the inductive interaction between the induction coil and the sensing element. The output of the sensing element may be an electrical signal. The output of the sensing element may be an electrical current. The output of the sensing element may be an electrical current induced in sensing element by the electrical signal supplied to the induction coil. The output of the sensing element may be a function of the electrical current induced in the sensing element. The output of the sensing element may depend on the susceptor.

The controller may be configured for identifying the inductive response of the susceptor in reaction to the supply of the electrical signal based on one or both of an electrical current and/or an electrical voltage of the supplied electrical signal.

The electrical current of the supplied electrical signal may be detected by the sensing element. The electrical voltage of the supplied electrical signal may be detected by a voltage measurement element.

The sensing element may be configured for detecting the current of the electrical signal supplied to the induction coil.

The controller may comprise a voltage measurement element. The controller may be configured for identifying the inductive response of the susceptor in reaction to the supply of the electrical signal based on an output of the voltage measurement element.

The voltage measurement element may be configured to measure the electrical voltage of the electrical signal supplied to the inductive heating assembly.

The voltage of the supplied electrical signal may vary over time. The controller may monitor the current of the supplied electrical signal and the voltage of the supplied electrical signal. The voltage measurement element may be coupled to the controller. The voltage measurement element may be configured to measure the voltage of the electrical signal. The controller may be connected to the voltage measurement element. The voltage measurement element may be configured to generate an output of the voltage measurement element. The output of the voltage measurement element may be one of the voltage of the supplied electrical signal or a signal based on the voltage of the supplied electrical signal. The controller may be configured monitor both, the current of the electrical signal and the voltage of the electrical signal. The change in the ratio of the supplied electrical current to the supplied electrical voltage may reflect the change of the conductance G of the susceptor over time. The change in the ratio of the supplied electrical current to the supplied electrical voltage may be indicative of the inductive response of the susceptor

The sensing element may be arranged at least partly, preferably fully, surrounding the cavity.

The sensing element may be arranged to encircle at least a part of the cavity. The center of the sensing coil may be arranged along the central longitudinal axis of the device. The sensing element may be arranged in a sidewall of the cavity.

The induction coil may be arranged at least partly, preferably fully, surrounding the cavity.

The induction coil may be arranged to encircle at least a part of the cavity. The center of the induction coil may be arranged along the central longitudinal axis of the device. The induction coil may be arranged in a sidewall of the cavity.

The sensing element may comprise a sensing coil. The sensing coil may be configured for receiving at least a portion of the induction coil.

The induction coil may be configured to abut the sensing element. The induction coil may be arranged adjacent to the sensing element. The induction coil may be arranged in close proximity to the sensing coil. The induction coil may be arranged to minimize electromagnetic interference.

The sensing coil may at least partly surround the induction coil. The sensing coil may be configured to at least partly receive the induction coil. The sensing coil and the induction coil may be arranged symmetrically around the central longitudinal axis of the device.

The sensing coil may be configured to provide a higher sensitivity than the induction coil. The sensitivity of the sensing coil may be enhanced by increasing or decreasing the number of turns of the sensing coil. The sensitivity of the sensing coil may be enhanced by tuning one or both of the geometry and shape. The sensing coil may comprise more or less turns than the induction coil.

The sensing element may comprise a sensing coil. The sensing coil may have a length of between 7 millimeters and 16 millimeters, preferably of between 5 millimeters and 11 millimeters.

The induction coil may have a length of between 15 millimeters and 31 millimeters, preferably of between 11 millimeters and 21 millimeters.

The length of the induction coil may be bigger than the length of the susceptor. The magnetic flux of the magnetic field of the electrical signal may pass through the susceptor.

The electrical signal may be an alternating electrical signal with a frequency of between 500 kHz and 30 MHz, preferably of between 5 MHz and 15 MHz, and most preferably of between 5 MHz and 10 MHz.

The controller may be configured for identifying the presence of an authorized aerosol-generating article based on the identification of one or more of a transient response and a frequency response. The controller may be configured for identifying the presence of an authorized aerosol-generating article based on the output of one or more of the sensing element and the voltage measurement element. The controller may be configured for identifying the presence of an authorized aerosol-generating article based on the electrical signal supplied to the induction coil. The controller may be configured for identifying the presence of an authorized aerosol-generating article based on the difference between the electrical signal supplied to the induction coil in the absence of the article in the cavity and the electrical signal supplied to the induction coil in the presence of the article in the cavity.

The controller may be configured for identifying a type of aerosol-generating article based on the identification of one or more of a transient response and a frequency response. The controller may be configured for identifying a type of aerosol-generating article based on the output of one or more of the sensing element and the voltage measurement element. The controller may be configured for identifying a type of aerosol-generating article based on the electrical signal supplied to the induction coil. The controller may be configured for identifying the type of an aerosol-generating article based on the difference between the electrical signal supplied to the induction coil in the absence of the article in the cavity and the electrical signal supplied to the induction coil in the presence of the article in the cavity.

The output of the sensing element may be an electrical signal induced in the sensing element. The output of the sensing element may be an electrical signal induced by inductive coupling between the induction coil and the sensing element. The output of the sensing element may be an electrical current induced in the sensing element. The output of the sensing element may be an electrical current induced by inductive coupling between the induction coil and the sensing element. The output of the sensing element may be an electrical current induced in the sensing element by the electrical signal supplied by the controller to the induction coil. The output of the sensing element may be a function of the current induced in the sensing element.

The output of the voltage measurement element may be a voltage. The output of the voltage measurement element may be the voltage of the electrical signal supplied by the controller to the induction coil. The output of the voltage measurement element may be a function of the voltage of the electrical signal supplied by the controller to the induction coil.

The controller may comprise a microprocessor, which may be a programmable microprocessor. The controller may be configured to regulate a supply of power to the induction coil. Power may be supplied to the induction coil continuously following activation of the aerosol-generating device or may be supplied intermittently, such as on a puff-by-puff basis. The power may be supplied to the induction coil in the form of pulses of electrical current.

The controller may comprise the sensing element. Alternatively, the controller and the sensing element may be separate elements. The controller may be configured to identify the presence of an authorized aerosol-generating article. The controller may be configured to identify the aerosol-generating article. The controller may be configured to identify a type of aerosol-generating article.

The controller may be configured to monitor one or more of the output of the sensing element, the output of the voltage measurement unit, the electrical signal supplied to the induction coil, the transient response and the frequency response.

The controller may be configured to monitor the progression of one or more of the output of the sensing element, the output of the voltage measurement unit, the electrical signal supplied to the induction coil, the transient response and the frequency response.

The controller may be configured to record one or more of the output of the sensing element, the output of the voltage measurement unit, the electrical signal supplied to the induction coil, the transient response and the frequency response.

The controller may be configured to process one or more of the output of the sensing element, the output of the voltage measurement unit, the electrical signal supplied to the induction coil, the transient response and the frequency response.

The controller may be configured to analyse one or more of the output of the sensing element, the output of the voltage measurement unit, the electrical signal supplied to the induction coil, the transient response and the frequency response.

The controller may be configured to identify the presence and/or absence of an authorized aerosol-generating article by processing one or more of the output of the sensing element, the output of the voltage measurement unit, the electrical signal supplied to the induction coil, the transient response and the frequency response. The controller may be configured to permit aerosol to be generated only after determining that an aerosol-generating article is present. The controller may be configured to prohibit aerosol generation, or cease aerosol generation, in response to determining that an aerosol-generating article is absent.

The controller may be configured to identify the type of the aerosol-generating article by processing one or more of the output of the sensing element, the output of the voltage measurement unit, the electrical signal supplied to the induction element, the transient response and the frequency response.

The controller may be configured to monitor one or both of the transient response and the frequency response by directly monitoring the electrical signal supplied to the induction coil.

The controller may be connected to the sensing element. The controller may be configured to communicate with the sensing element. The controller may be connected to the induction coil. The controller may be configured to communicate with the induction coil. The controller may be connected to the voltage measurement element. The controller may be configured to communicate with the voltage measurement element.

The controller may comprise a memory. The memory may comprise pre-stored reference data. The reference data may comprise reference outputs to of the sensing element. The reference data may comprise reference outputs to of the voltage measurement element. The reference data may comprise reference electrical signals supplied to the induction coil. The reference data may comprise reference electrical signals supplied to the induction coil in the absence of the article and reference electrical signals supplied to the induction coil in the presence of the article. The reference data may comprise reference transient responses. The reference data may comprise the difference of the electrical signal supplied to the induction coil in the absence of article and the electrical signal supplied to the induction coil in the presence of the article. The reference data may comprise reference transient responses. The reference data may comprise reference frequency responses. Such references may correspond to a susceptor of known configuration and arrangement.

The controller may be configured to identify the difference between the electrical signal supplied to the induction coil in the absence of the article in the cavity and the electrical signal supplied to the induction coil in the presence of the article in the cavity. The difference between the electrical signal supplied to the induction coil in the absence of the article in the cavity and the electrical signal supplied to the induction coil in the presence of the article in the cavity may result from the inductive interaction between the alternating electromagnetic field of the electrical signal and the susceptor of the article.

The controller may be configured to compare the output of the sensing element with the pre-stored reference data. The controller may be configured to compare the output of the voltage measurement element with the pre-stored reference data. The controller may be configured to compare the electrical signal supplied to the induction coil with the pre-stored reference data. The controller may be configured to compare one or more of the transient response and the frequency response with the pre-stored reference data. The controller may be configured to compare the difference between the electrical signal supplied to the induction coil in the absence of the article in the cavity and the electrical signal supplied to the induction coil in the presence of the article in the cavity with the pre-stored reference data.

The controller may be configured to correlate the output of the sensing element with the pre-stored reference data. The controller may be configured to correlate the output of the voltage measurement element with the pre-stored reference data The controller may be configured to correlate the electrical signal supplied to the induction coil with the pre-stored reference data. The controller may be configured to correlate one or more of the transient response and the frequency response with the pre-stored reference data. The controller may be configured to correlate the difference between the electrical signal supplied to the induction coil in the absence of the article in the cavity and the electrical signal supplied to the induction coil in the presence of the article in the cavity with the pre-stored reference data.

The controller may be configured to identify the presence of an authorized article by correlating the output of the sensing element with the pre-stored reference data. The controller may be configured to identify the presence of an authorized article by correlating the output of the voltage measurement element with the pre-stored reference data. The controller may be configured to identify the presence of an authorized article by correlating the electrical signal supplied to the induction coil with the pre-stored reference data. The controller may be configured to identify the presence of an authorized article by correlating one or more of the transient response and the frequency response with the pre-stored reference data. The controller may be configured to identify the presence of an authorized article by correlating the difference between the electrical signal supplied to the induction coil in the absence of the article in the cavity and the electrical signal supplied to the induction coil in the presence of the article in the cavity with the pre-stored reference data.

The controller may be configured to identify the article type by correlating the output of the sensing element with the pre-stored reference data. The controller may be configured to identify the article type by correlating the output of the voltage measurement element with the pre-stored reference data. The controller may be configured to identify the article type by correlating the electrical signal supplied to the induction coil with the pre-stored reference data. The controller may be configured to identify the article type by correlating one or more of the transient response and the frequency response with the pre-stored reference data. The controller may be configured to identify the article type by correlating the difference between the electrical signal supplied to the induction coil in the absence of the article in the cavity and the electrical signal supplied to the induction coil in the presence of the article in the cavity with the pre-stored reference data.

The controller may be configured to regulate power supply to the induction coil based on the identification of the presence of the authorized aerosol-generating article. The controller may be configured to regulate power supply to the induction coil based on the identification of the aerosol-generating article. The controller may be configured to regulate power supply to the induction coil based on the identification of the type of the aerosol-generating article. Upon identification of a known aerosol-generating article, the controller may allow power to be supplied to the induction coil. Upon identification of a known aerosol-generating article, the controller may allow the provision of a user experience. Upon the absence of identification of a known aerosol-generating article, the controller may block power supply to the induction coil. Upon the absence of identification of a known aerosol-generating article, the controller may prevent the provision of a user experience.

The controller may be configured to regulate power supply to the induction coil based on the identification of a type of aerosol-generating article. Upon identification of a type of aerosol-generating article, the controller may allow power to be supplied to the induction coil. Upon identification of a type of aerosol-generating article, the controller may allow power to be continued to be supplied to the induction coil. Upon identification of the presence of an authorized aerosol-generating article, the controller may allow power to be continued to be supplied to the induction coil. Upon identification of a type of aerosol-generating article, the controller may allow the provision of a user experience. Upon identification of a type of aerosol-generating article, the controller may adjust the power supply in dependence on the article type identified. The controller may be configured to provide power to the induction coil according to a predefined heating profile for the respective identified article.

The controller may be configured adjust the power supply in dependence on the article type identified. The controller may adjust the magnitude of power supply in dependence on the article type identified. The controller may adjust the time period of power supply in dependence on the article type identified. The controller may adjust the temperature of the susceptor in dependence on the article type identified. The controller may adjust one or more of the amplitude and the frequency of a current supplied to the induction coil in dependence on the article type identified. The controller may adjust the signal powering the induction coil in dependence on the article type identified.

The memory of the controller may comprise a database of pre-stored heating profiles for each known type of aerosol-generating article. The controller may be configured to provide power according to the heating profile of the identified type of aerosol-generating article. Power supply may be tailored to the configuration of a specific article type. Aerosol-generation and the user experience may be optimized.

The controller may be configured to control the operation of the aerosol-generating device.

In a second aspect, the invention relates to an aerosol-generating article for use with an aerosol-generating device, wherein the article comprises an aerosol-forming substrate, wherein the article comprises at least one susceptor, wherein the shape, size and/or material of the susceptor is adapted for triggering an inductive response for identification at the aerosol-generating device.

According to another aspect, there is provided an aerosol-generating article for use with an aerosol-generating device. The article may comprise an aerosol-forming substrate. The article may comprise at least one susceptor. The shape, size and/or material of the susceptor may be adapted for triggering an inductive response for identification at the aerosol-generating device. of an induction coil in the device.

According to another aspect, there is provided an aerosol-generating article for use with an aerosol-generating device. The article may comprise an aerosol-forming substrate. The article may comprise at least one susceptor. The susceptor may be configured for triggering an inductive response of an induction coil in the device.

The susceptor may be configured to inductively interact with the induction coil. The susceptor may be configured to inductively interact with the induction coil to trigger the inductive response of the induction coil. The susceptor may be configured to inductively interact with the electrical signal supplied to the induction coil to trigger the inductive response of the induction coil.

The inductive response of the induction coil may be the adaption of the electrical signal supplied to the induction coil in response to the presence of the susceptor of an article received in the cavity of the device.

The inductive response of the induction coil may be specific to the susceptor. The inductive response of the induction coil may depend on one or more of the size, material, shape, number and location of susceptor.

The heating profile of a susceptor may be adjusted by varying one or more of the size, shape and material of the susceptor. The surface temperature distribution of the susceptor may be adjusted by varying one or more of the size, shape and material of the susceptor. The heating profile of a susceptor may be adjusted by varying the material of the susceptor. One or more of the size, shape and material of the susceptor may be varied to provide an optimized heating profile for a specific aerosol-generating article and aerosol-forming substrate. One or more of the size, shape and material of the susceptor may be varied to provide an optimized surface temperature distribution for a specific aerosol-generating article and aerosol-forming substrate.

The susceptor may have an impact on the inductive response on the electrical signal supplied to the induction coil in the device.

The shape of the susceptor may be selected from a rectangular shape with at least one through-hole, a parallelogrammatic shape with at least one undulating edge and a helical shape.

The shape of the susceptor may be varied to achieve a specific inductive response of the susceptor. The shape of the susceptor may be varied to achieve a specific inductive response of the induction coil.

The heating profile of a susceptor may be adjusted by varying the shape of the susceptor. The surface temperature distribution of the susceptor may be adjusted by varying the shape of the susceptor. The shape of the susceptor may be adapted to provide an optimized heating profile for a specific aerosol-generating article and aerosol-forming substrate. The shape of the susceptor may be adapted to provide an optimized surface temperature profile of the susceptor for a specific aerosol-generating article and aerosol-forming substrate.

The susceptor may have a rectangular shape with four through-holes. The susceptor may have a width of 5 millimeters. The susceptor may have length of 11 millimeters. Additional eddy currents may be generated around the areas near these through-holes. This may lead to a faster increase in temperature of the areas near these through-holes than the remaining parts of the susceptor. Inclusion of the four through holes may adapt the heating profile of the rectangular susceptor.

An undulating edge may be a zigzag edge. The susceptor may have a parallelogrammatic shape with two undulating edges. The edges of the susceptor of parallelogrammatic shape facing the lateral outer surface of the article may be undulating edges. The edges of the susceptor of parallelogrammatic shape facing the lateral outer surface of the article may be undulating edges zigzag edges.

The susceptor may comprise at least a first portion and a second portion. The first portion may be made from a different material than the second portion.

The heating profile of the susceptor may be varied by providing a susceptor comprising two or more portions made from differing material. The surface temperature distribution of the susceptor may be varied by providing a susceptor comprising two or more portions made from differing material. The first portion of the susceptor may be in contact with the second portion of the susceptor. The material of the first portion may have a different Curie temperature than the material of the second portion. The first portion may be made of one of ferritic stainless steel, copper and bronze. The second portion may be made of one of ferritic stainless steel, copper and bronze.

The material of the susceptor may be varied to achieve a specific inductive response of the susceptor. The material of the susceptor may be varied to achieve a specific inductive response of the induction coil. The material one or both of the first portion and the second portion of the susceptor may be varied to achieve a specific inductive response of the susceptor. The material one or both of the first portion and the second portion of the susceptor may be varied to achieve a specific inductive response of the induction coil.

The article may comprise at least two susceptors. Preferably each of the susceptors has a rectangular shape.

The article may comprise a multitude of susceptors each having a rectangular shape. The susceptors may be distributed in the aerosol-forming substrate of the article. The susceptors may have different lengths. Using a multitude of susceptors may improve uniformity of the heat distribution within the aerosol-forming substrate.

The susceptor may have a length of between 7 millimeters and 25 millimeters, preferably of between 9 millimeters and 15 millimeters, a width of between 3 millimeters and 11 millimeters, preferably of between 4 millimeters and 7 millimeters and a thickness of between 3 millimeters and 6 millimeters.

The susceptor may have a Curie temperature of between 200 °C and 450 °C, preferably of between 240 °C and 400 °C. The susceptor may have a Curie temperature of 280 °C.

By the term “Curie temperature” is generally understood as the temperature at, which a magnetic material loses its magnetic properties in the absence of an external magnetic field. Hence, the Curie temperature is a temperature at which a ferro- or ferri-magnetic material undergoes a phase change and becomes paramagnetic.

One or more of the specificity and interaction strength of the susceptor may be varied by tuning the configuration of the susceptor. A first article may have a first susceptor having a first configuration. A second article may have a second susceptor having a second configuration. The first configuration may be different from the second configuration.

The size of the susceptor may be varied. The size of a component may be the spatial extension of the component. A first article may have a first susceptor having a first size. A second article may have a second susceptor having a second size. The first size may be different from the second size.

The material of the susceptor may be varied. A first article may have a first susceptor having a first material. A second article may have a second susceptor having a second material. The first material may be different from the second material.

The shape of the susceptor may be varied. The shape of a component may be the external form, contours or outline of the component. A first article may have a first susceptor having a first shape. A second article may have a second susceptor having a second shape. The first shape may be different from the second shape.

The number of susceptors in an article may be varied. A first article may have a first number of susceptors. A second article may have a second number of susceptors. The first number of susceptors may be different from the second number of susceptors.

In a third aspect, the invention relates to a set comprising at least a first aerosol-generating article and a second aerosol-generating article as described herein, wherein the susceptor of the first article is configured to differ from the susceptor of the second article in terms of one or more of susceptor shape, susceptor size and susceptor material.

According to another aspect, the invention relates to a set comprising at least a first aerosol-generating article and a second aerosol-generating article as described herein. The susceptor of the first article may be configured to differ from the susceptor of the second article in terms of one or more of susceptor shape, susceptor size and susceptor material.

In a fourth aspect, the invention relates to an aerosol-generating system comprising an aerosol-generating device as described herein and an aerosol-generating article as described herein.

The system may comprise an aerosol-generating device as described herein and a plurality of different aerosol-generating articles as described herein. Each one of the plurality of different aerosol-generating articles may comprise an aerosol-forming substrate and a susceptor. Each susceptor of each one of the plurality of different aerosol-generating articles may differ from the other susceptors of the plurality of different aerosol-generating articles in terms of one or more of susceptor shape, susceptor size and susceptor material.

In a fifth aspect, the invention relates to a method for identifying an aerosol-generating article in an aerosol-generating device of an aerosol-generating system described herein, wherein the method comprises identifying an inductive response of the susceptor in reaction to the supply of the electrical signal.

According to another aspect, there is provided a method for identifying an aerosol-generating article in an aerosol-generating device of an aerosol-generating system, preferably the system described herein. The method may comprise identifying an inductive response of the susceptor in reaction to the supply of the electrical signal.

The method may comprise supplying an electrical signal to the induction coil.

The method may comprise inserting the aerosol-generating article into the cavity of the aerosol-generating device.

The method may include identifying, via the controller, the type of the aerosol-generating article based on the output of the sensing element.

The method may include identifying, via the controller, the type of the aerosol-generating article based on one or more of the transient response and the frequency response.

The method may include identifying, via the controller, the type of the aerosol-generating article based on the difference between the electrical signal supplied to the induction coil in the absence of the article including the susceptor in the cavity and the electrical signal supplied to the induction coil in the presence of the article including the susceptor in the cavity

The method may include identifying, via the controller, the presence of an authorized aerosol-generating article based on the output of the sensing element.

The method may include identifying, via the controller, the presence of an authorized aerosol-generating article based on the one or more of the transient response and the frequency response.

The method may include identifying, via the controller, the presence of an authorized aerosol-generating article based on the difference between the electrical signal supplied to the induction coil in the absence of the article including the susceptor in the cavity and the electrical signal supplied to the induction coil in the presence of the article including the susceptor in the cavity

The method may comprise the step of identifying the aerosol-generating article by comparing the output of the sensing element with reference data. The method may comprise the step of identifying the type of the aerosol-generating article by comparing the output of the sensing element with reference data. The method may comprise the step of identifying the aerosol-generating article by comparing one or both the transient response and the frequency response with reference data. The method may comprise the step of identifying the aerosol-generating article by comparing the difference between the electrical signal supplied to the induction coil in the absence of the article including the susceptor in the cavity and the electrical signal supplied to the induction coil in the presence of the article including the susceptor in the cavity with reference data.

The method may comprise the step of controlling operation of the aerosol-generating device depending upon the identification of the presence of an authorized aerosol-generating article.

The method may comprise the step of controlling operation of the aerosol-generating device depending upon the identification of type of the inserted aerosol-generating article.

The method may comprise that controlling the operation of the aerosol-generating device may include deactivating operation of the aerosol-generating device if an authorized aerosol-generating article is not identified.

The method may comprise that controlling the operation of the aerosol-generating device includes choosing a heating profile of the aerosol-generating device depending upon the identified aerosol-generating article.

The method may comprise that controlling the operation of the aerosol-generating device includes choosing a heating profile of the aerosol-generating device depending upon the identified type of aerosol-generating article.

As used herein, the terms ‘proximal', 'distal', 'downstream’ and ‘upstream’ are used to describe the relative positions of components, or portions of components, of the aerosol-generating device and the aerosol-generating article in relation to the direction in which a user draws on the aerosol-generating device or aerosol-generating article during use thereof.

A longitudinal axis of a component may be an axis along or parallel to the lengthwise direction of the component. A longitudinal axis of the device may extend between the distal end and the proximal end of the device. A longitudinal axis of the article may extend between the distal end and the proximal end of the article.

The aerosol-generating system may comprise a mouth end through which in use an aerosol exits the aerosol-generating system and is delivered to a user. The mouth end may also be referred to as the proximal end. In use, a user draws on the proximal or mouth end of the aerosol-generating system in order to inhale an aerosol generated by the aerosol-generating system. The aerosol-generating system comprises a distal end opposed to the proximal or mouth end. The proximal or mouth end of the aerosol-generating system may also be referred to as the downstream end and the distal end of the aerosol-generating system may also be referred to as the upstream end. Components, or portions of components, of the aerosol-generating system may be described as being upstream or downstream of one another based on their relative positions between the proximal, downstream or mouth end and the distal or upstream end of the system.

The aerosol-generating device may comprise a mouth end through which in use an aerosol exits the aerosol-generating device and is delivered to a user. In use, a user draws on the proximal or mouth end of the aerosol-generating device in order to inhale an aerosol generated by the aerosol-generating device. Alternatively, a user may directly draw on an aerosol-generating article inserted into an opening at the proximal end of the aerosol-generating device. The opening at the proximal end may be an opening of the cavity. The aerosol-generating device comprises a distal end opposed to the proximal or mouth end. The proximal or mouth end of the aerosol-generating device may also be referred to as the downstream end and the distal end of the aerosol-generating device may also be referred to as the upstream end. Components, or portions of components, of the aerosol-generating device may be described as being upstream or downstream of one another based on their relative positions between the proximal, downstream or mouth end and the distal or upstream end of the aerosol-generating device.

As used herein, an ‘aerosol-generating device’ relates to a device that interacts with an aerosol-forming substrate to generate an aerosol. The aerosol-forming substrate may be part of an aerosol-generating article, for example part of a smoking article. An aerosol-generating device may be a smoking device that interacts with an aerosol-forming substrate of an aerosol-generating article to generate an aerosol that is directly inhalable into a user's lungs thorough the user's mouth. An aerosol-generating device may be a holder. The device may be an electrically heated smoking device. The aerosol-generating device may comprise a housing, electric circuitry, a power supply, a heating chamber and an induction coil.

As used herein with reference to the present invention, the term ‘smoking’ with reference to a device, article, system, substrate, or otherwise does not refer to conventional smoking in which an aerosol-forming substrate is fully or at least partially combusted. The aerosol-generating device of the present invention is arranged to heat the aerosol-forming substrate to a temperature below a combustion temperature of the aerosol-forming substrate, but at or above a temperature at which one or more volatile compounds of the aerosol-forming substrate are released to form an inhalable aerosol.

The aerosol-generating device may have length of between 86 millimeters to 130 millimeters.

The cavity of the aerosol-generating device may have an open end into which the aerosol-generating article is inserted. The open end may be a proximal end. The cavity may have a closed end opposite the open end. The closed end may be the base of the cavity. The closed end may be closed except for the provision of air apertures arranged in the base. The base of the cavity may be flat. The base of the cavity may be circular. The base of the cavity may be arranged upstream of the cavity. The open end may be arranged downstream of the cavity. The cavity may have an elongate extension. The cavity may have a longitudinal central axis. A longitudinal direction may be the direction extending between the open and closed ends along the longitudinal central axis. The longitudinal central axis of the cavity may be parallel to the longitudinal axis of the aerosol-generating device.

The cavity may be configured as a heating chamber. The cavity may have a cylindrical shape. The cavity may have a hollow cylindrical shape. The cavity may have a shape corresponding to the shape of the aerosol-generating article to be received in the cavity. The cavity may have a circular cross-section. The cavity may have an elliptical or rectangular cross-section. The cavity may have an inner diameter corresponding to the outer diameter of the aerosol-generating article.

An airflow channel may run through the cavity. Ambient air may be drawn into the aerosol-generating device, into the cavity and towards the user through the airflow channel. Downstream of the cavity, a mouthpiece may be arranged or a user may directly draw on the aerosol-generating article. The airflow channel may extend through the mouthpiece. The cavity may have a length of between 28 millimeters and 67 millimeters.

An induction heating element may comprise the induction coil and the susceptor. In general, a susceptor is a material that is capable of generating heat, when penetrated by an alternating magnetic field. If the susceptor is conductive, then typically eddy currents are induced by the alternating magnetic field. If the susceptor is magnetic, then typically another effect that contributes to the heating is commonly referred to hysteresis losses. Hysteresis losses occur mainly due to the movement of the magnetic domain blocks within the susceptor, because the magnetic orientation of these will align with the magnetic induction field, which alternates. Another effect contributing to the hysteresis loss is when the magnetic domains will grow or shrink within the susceptor. Commonly all these changes in the susceptor that happen on a nano-scale or below are referred to as “hysteresis losses”, because they produce heat in the susceptor. Hence, if the susceptor is both magnetic and electrically conductive, both hysteresis losses and the generation of eddy currents will contribute to the heating of the susceptor. If the susceptor is magnetic, but not conductive, then hysteresis losses will be the only means by which the susceptor will heat, when penetrated by an alternating magnetic field. According to the invention, the susceptor may be electrically conductive or magnetic or both electrically conductive and magnetic. An alternating magnetic field generated by one or several induction coils heat the susceptor, which then transfers the heat to the aerosol-forming substrate, such that an aerosol is formed. The heat transfer may be mainly by conduction of heat. Such a transfer of heat is best, if the susceptor is in close thermal contact with the aerosol-forming substrate.

The susceptor may be formed from any material that can be inductively heated to a temperature sufficient to generate an aerosol from the aerosol-forming substrate. A preferred susceptor may comprise or consist of a ferromagnetic material or ferri-magnetic material, for example a ferromagnetic alloy, ferritic iron, or a ferromagnetic steel or stainless steel. A suitable susceptor may be, or comprise, aluminium. Preferred susceptors may be heated to a temperature in excess of 250 degrees Celsius.

The susceptor material may be selected from the group consisting of an electrically-conductive material, a magnetic material, and a non-magnetic material, for example, aluminum, gold, iron, nickel, cobalt, conductive carbon, graphite, plain-carbon steel, stainless steel, ferritic stainless steel, copper, and bronze.

Preferably, the susceptor material is a metallic susceptor material (by metallic is meant a metal in a non-oxide form, which usually is referred to as ceramics). The susceptor may also be a multi-material susceptor and may comprise a first susceptor material and a second susceptor material. The first portion of the susceptor may be made from the first susceptor material. The second portion of the susceptor may be made from the second susceptor material. In some embodiments, the first susceptor material may be disposed in intimate physical contact with the second susceptor material. The first and/or second susceptor material preferably has a Curie temperature that is below the combustion temperature of the aerosol-forming substrate. The first susceptor material may be used primarily to heat the susceptor when the susceptor is placed in a fluctuating electromagnetic field. Any suitable material may be used. For example the first susceptor material may be aluminium, or may be a ferrous material such as a stainless steel. The second susceptor material may be used primarily to indicate when the susceptor has reached a specific temperature, that temperature being the Curie temperature of the second susceptor material. The Curie temperature of the second susceptor material can be used to regulate the temperature of the entire susceptor during operation. Suitable materials for the second susceptor material may include nickel and certain nickel alloys.

By providing a susceptor having at least a first and a second susceptor material, the heating of the aerosol-forming substrate and the temperature control of the heating may be essentially separated.

The aerosol-generating device may comprise a power supply, typically a battery, within a main body of the aerosol-generating device. In one embodiment, the power supply is a Lithium-ion battery. Alternatively, the power supply may be a Nickel-metal hydride battery, a Nickel cadmium battery, or a Lithium based battery, for example a Lithium-Cobalt, a Lithium-Iron-Phosphate, Lithium Titanate or a Lithium-Polymer battery. As an alternative, the power supply may be another form of charge storage device such as a capacitor. The power supply may require recharging and may have a capacity that enables to store enough energy for one or more usage experiences; for example, the power supply may have sufficient capacity to continuously generate aerosol for a period of around six minutes or for a period of a multiple of six minutes. In another example, the power supply may have sufficient capacity to provide a predetermined number of puffs or discrete activations of the induction coil.

As used herein, the term ‘aerosol-forming substrate’ relates to a substrate capable of releasing one or more volatile compounds that can form an aerosol. Such volatile compounds may be released by heating the aerosol-forming substrate. An aerosol-forming substrate may conveniently be part of an aerosol-generating article.

The aerosol-forming substrate may be a solid aerosol-forming substrate. The aerosol-forming substrate may comprise both solid and liquid components. The aerosol-forming substrate may comprise a tobacco-containing material containing volatile tobacco flavour compounds which are released from the substrate upon heating. The aerosol-forming substrate may comprise a non-tobacco material. The aerosol-forming substrate may comprise an aerosol former that facilitates the formation of a dense and stable aerosol. Examples of suitable aerosol formers are polyhydric alcohols, such as propylene glycol, triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate.

The aerosol-generating substrate preferably comprises homogenised tobacco material, an aerosol-former and water. Providing homogenised tobacco material may improve aerosol generation, the nicotine content and the flavour profile of the aerosol generated during heating of the aerosol-generating article. Specifically, the process of making homogenised tobacco involves grinding tobacco leaf, which more effectively enables the release of nicotine and flavours upon heating.

As used herein, the term ‘aerosol-generating article’ refers to an article comprising an aerosol-forming substrate that is capable of releasing volatile compounds that can form an aerosol. For example, an aerosol-generating article may be a smoking article that generates an aerosol that is directly inhalable into a user's lungs through the user's mouth. An aerosol-generating article may be disposable.

The aerosol-generating article may be substantially cylindrical in shape. The aerosol-generating article may be substantially elongate. The aerosol-generating article may have a length and a circumference substantially perpendicular to the length. The aerosol-generating article may be substantially rod shaped. The aerosol-forming substrate may be substantially cylindrical in shape. The aerosol-forming substrate may be substantially elongate. The aerosol-forming substrate may also have a length and a circumference substantially perpendicular to the length. The aerosol-forming substrate may be substantially rod shaped.

The aerosol-generating article may have a total length between 55 millimeters and 110 millimeters, preferably of between 60 millimeters and 90 millimeters. The aerosol-generating article may have an external diameter between 4.5 millimeters and 17 millimeters, preferably between 6 millimeters and 9 millimeters. The aerosol-generating article may comprise a filter plug. The filter plug may be located at a downstream end of the aerosol-generating article. The filter plug may be a cellulose acetate filter plug. The filter plug may be approximately 7 millimeters in length in one embodiment, but may have a length of between approximately 5 millimeters to approximately 10 millimeters. The aerosol-generating article may comprise an outer paper wrapper

The aerosol-generating article may comprise a separation between the aerosol-forming substrate and the filter plug. The separation may be approximately 18 millimeters, but may be in the range of 5 millimeters to 25 millimeters.

Below, there is provided a non-exhaustive list of non-limiting examples. Any one or more of the features of these examples may be combined with any one or more features of another example, embodiment, or aspect described herein.

The invention is defined in the claims. However, below there is provided a non-exhaustive list of non-limiting examples. Any one or more of the features of these examples may be combined with any one or more features of another example, embodiment, or aspect described herein.

Example 1: An aerosol-generating device comprising a cavity configured for receiving an aerosol-generating article comprising an aerosol-forming substrate, wherein the aerosol-forming substrate comprises a susceptor, an induction coil for heating the susceptor and a controller, wherein the controller is configured for supplying an electrical signal to the induction coil, and wherein the controller is configured for identifying an inductive response of the susceptor in reaction to the supply of the electrical signal.

Example 1A: An aerosol-generating device for use with a plurality of different aerosol-generating articles, wherein each one of the plurality of different aerosol-generating articles comprises an aerosol-forming substrate and a susceptor, wherein each susceptor of each one of the plurality of different aerosol-generating articles differs from the other susceptors of the plurality of different aerosol-generating articles in terms of one or more of susceptor shape, susceptor size and susceptor material, and wherein the aerosol-generating device comprises: a cavity configured for receiving one of the plurality of different aerosol-generating articles, an induction coil for heating the susceptor and a controller, wherein the controller is configured for supplying an electrical signal to the induction coil, wherein the controller is configured for identifying an inductive response of the susceptor in reaction to the supply of the electrical signal, and wherein the controller is configured for differentiating between the plurality of different aerosol-generating articles based on the susceptor shape, susceptor size and susceptor material in order to identify the aerosol-generating article received in the cavity.

Example 1B: The aerosol-generating device according to example 1 or example 1A wherein the controller is configured to: (i) identify the presence an authorized article in the device, (ii) identify the type of the inserted article, (iii) regulate operation of the device in dependence on the characteristics of the inserted article, and/or (iv) determine the presence and/or absence of an article in the device, based on the identified inductive response.

Example 2: The aerosol-generating device according to example 1, 1A or 1B, wherein the controller is configured for identifying one or both of a transient response and a frequency response.

Example 3: The aerosol-generating device according to any of the preceding examples, wherein the device comprises a sensing element, preferably wherein the sensing element comprises a sensing coil, wherein the sensing element is configured for detecting the inductive response of the susceptor in reaction to the supply of the electrical signal, and wherein the controller is configured for identifying the inductive response of the susceptor in reaction to the supply of the electrical signal based on a sensing element output.

Example 4: The aerosol-generating device according to any of the preceding examples, wherein the controller is configured for identifying the inductive response of the susceptor in reaction to the supply of the electrical signal based on one or both of an electrical current and an electrical voltage of the supplied electrical signal.

Example 5: The aerosol-generating device according to example 4, wherein the sensing element is configured for detecting the current of the electrical signal supplied to the induction coil.

Example 6: The aerosol-generating device according to any of examples 4 and 5, wherein the controller comprises a voltage measurement element, wherein the controller is configured for identifying the inductive response of the susceptor in reaction to the supply of the electrical signal based on an output of the voltage measurement element.

Example 7: The aerosol-generating device according to any of examples 3 to 6, wherein the sensing element is arranged at least partly, preferably fully, surrounding the cavity.

Example 8: The aerosol-generating device according to any of one of the preceding examples, wherein the induction coil is arranged at least partly, preferably fully, surrounding the cavity.

Example 9: The aerosol-generating device according to any of examples 3 to 8, wherein the sensing element comprises a sensing coil, and wherein the sensing coil is configured for receiving at least a portion of the induction coil.

Example 10: The aerosol-generating device according to any of examples 3 to 9, wherein the sensing element comprises a sensing coil, and wherein the sensing coil has a length of between 7 millimeters and 16 millimeters, preferably of between 5 millimeters and 11 mm millimeters

Example 11: The aerosol-generating device according to any of the preceding examples, wherein the induction coil has a length of between 15 millimeters and 31 millimeters, preferably of between 11 millimeters and 21 millimeters.

Example 12: The aerosol-generating device according to any of the preceding examples, wherein the electrical signal may be an alternating electrical signal with a frequency of between 500 kHz and 30 MHz, preferably of between 5 MHz and 15 MHz, and most preferably of between 5 MHz and 10 MHz.

Example 13: The aerosol-generating device according to any of the preceding examples, wherein the controller is configured to supply an identifying signal to the induction coil, wherein the identifying signal comprises a specific waveform for identifying one or more susceptors, wherein the controller is configured to identify the inductive response of the susceptor in reaction to the supply of the identification signal, wherein the controller is configured to supply a heating signal to the induction coil after applying the identification signal, wherein the heating signal differs from the identification signal at least in terms of one or both of its frequency and amplitude.

Example 14. The aerosol-generating device according to example 13, wherein the waveform is selected from the group consisting of a sawtooth, sinusoidal, square, or triangular waveform.

Example 15: An aerosol-generating article for use with an aerosol-generating device, wherein the article comprises an aerosol-forming substrate, wherein the article comprises at least one susceptor, wherein the susceptor is configured for triggering an inductive response of the susceptor in the device.

Example 15A: An aerosol-generating article for use with an aerosol-generating device, wherein the article comprises an aerosol-forming substrate, wherein the article comprises at least one susceptor, wherein the shape, size and/or material of the susceptor is adapted for triggering an inductive response for identification at the aerosol-generating device.

Example 16: The aerosol-generating article according to example 15 or example 15A, wherein the shape of susceptor is selected from a rectangular shape with one or more through-holes, a parallelogrammatic shape with at least one undulating edge and a helical shape.

Example 17: The aerosol-generating article according to any of examples 15 to 16, wherein the susceptor comprises at least a first portion and a second portion, wherein the first portion is made from a different material than the second portion.

Example 18: The aerosol-generating article according to any of examples 15 to 17, wherein the article comprises at least two susceptors, preferably wherein each of the susceptors has a rectangular shape.

Example 19: The aerosol-generating article according to any of examples 15 to 18, wherein the susceptor has a length of between 7 millimeters and 25 millimeters, preferably of between 9 m millimeters m and 15 millimeters, a width of between 3 millimeters and 11 millimeters, preferably of between 4 millimeters and 7 millimeters and a thickness of between 3 millimeters and 6 millimeters.

Example 20: The aerosol-generating article according to any of examples 15 to 19, wherein the susceptor has a Curie temperature of between 200 °C and 450 °C, preferably of between 240 °C and 400 °C.

Example 21: A set comprising at least a first aerosol-generating article and a second aerosol-generating article according to any of examples 15 to 20, wherein the susceptor of the first article is configured to differ from the susceptor of the second article in terms of one or more of susceptor shape, susceptor size and susceptor material.

Example 22: An aerosol-generating system comprising an aerosol-generating device according to any of examples 1 to 14 and an aerosol-generating article, preferably according to any of examples 15 to 20.

Example 23: A method for identifying an aerosol-generating article in an aerosol-generating device of an aerosol-generating system, preferably according to example 22, wherein the method comprises identifying an inductive response of the susceptor in reaction to the supply of the electrical signal.

Features described in relation to one embodiment may equally be applied to other embodiments of the invention.

The invention will be further described, by way of example only, with reference to the accompanying drawings in which:

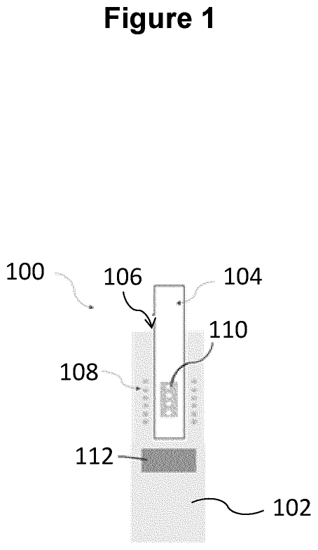

FIG. 1 shows an embodiment of the aerosol-generating system of invention including an aerosol-generating device comprising an induction coil.

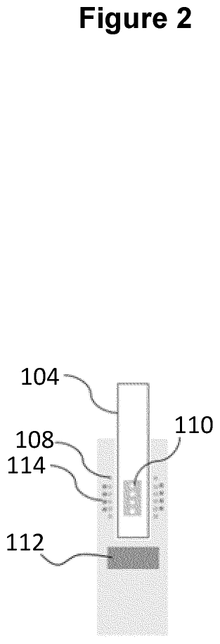

FIG. 2 shows an embodiment of the aerosol-generating system of invention including an aerosol-generating device comprising a sensing coil an aerosol-generating article with a first susceptor.

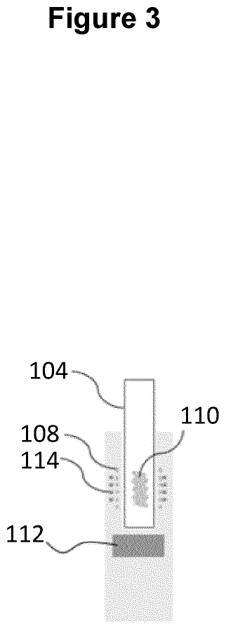

FIG. 3 shows an embodiment of the aerosol-generating system of invention including an aerosol-generating article with a second susceptor.

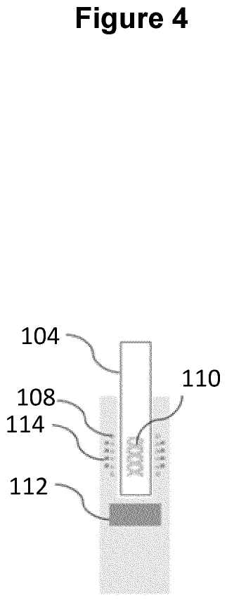

FIG. 4 shows an embodiment of the aerosol-generating system of invention including an aerosol-generating article with a third susceptor.

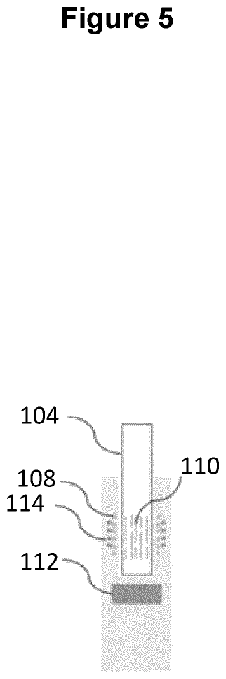

FIG. 5 shows an embodiment of the aerosol-generating system of invention including an aerosol-generating article with a multitude of susceptors.

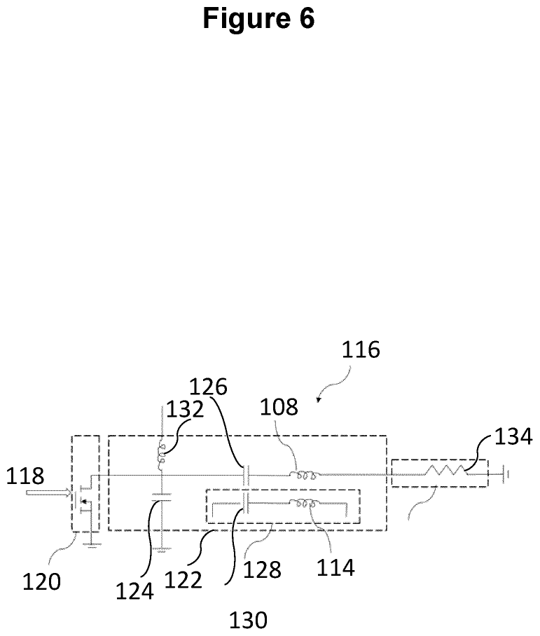

FIG. 6. shows a schematic inductive heating arrangement used in the aerosol-generating device of the invention.

FIG. 1 shows an embodiment of the aerosol-generating system 100 of the invention. The system comprises an aerosol-generating device 102 and an aerosol-generating article 104. The article 104 is shown to be fully inserted into a cavity 106 of the device 102. The device 102 comprises an induction coil 108. The induction coil 108 fully surrounds the cavity 106 of the device.

The article 104 comprises a susceptor 110. The article 104 comprises an aerosol-forming substrate. The susceptor 110 is preferably arranged within the aerosol-forming substrate. The susceptor 110 has a rectangular shape including four through holes. The susceptor 110 is positioned fully within the induction coil 108. The induction coil 108 is configured to be longer than the susceptor 110. The longitudinal axis of the susceptor 110 is arranged parallel to the longitudinal axis of the article 104.

By positioning the susceptor 110 fully within the induction coil 108, inductive coupling between the susceptor 110 and the induction coil 108 is optimized.

The device further comprises a controller 112. The controller 112 supplies an electrical signal to the induction coil 108. The susceptor 110 interacts inductively with the induction coil 108. The transient response and the frequency response of the electrical signal depend on the inductive interaction between the susceptor 110 and the induction coil 108. Such inductive interaction depends on one or more of the shape, size, and material of the susceptor 110. The rectangular susceptor 110 with the four through holes triggers a specific transient response and frequency response. The controller 110 monitors one or both of the transient response and the frequency response.

The controller 112 further comprises a storage of reference data. The controller 112 compares the one or both of the monitored transient response and frequency response with the reference data. The controller 112 may correlate the one or both of the monitored transient response and frequency response with the reference data. Based on such comparison, the controller 112 may identify the one or more of the transient response and the frequency response. Based on such comparison, the controller 112 may identify if the inserted article is an authorized article. Based on such comparison, the controller 112 may identify the type of article inserted.

Detection and identification based on one or both of the transient response and frequency response may require minimum modification of existing devices. Detection and identification based on one or both of the transient response and frequency response may be cost-effective as the transient response and frequency response can be directly monitored by the controller.

The electrical signal supplied to the induction coil may be an electrical signal which provides sufficient power to allow aerosol generation. The electrical signal supplied to the induction coil may be an electrical signal which does not provide sufficient power to allow aerosol generation. In another example, the controller 112 supplies a first electrical signal to the induction coil, which may be described as an identifying signal. This identifying signal may comprise of a specific waveform for identifying one or more susceptors, e.g., one or more susceptors having different shapes and/or sizes. The waveform may be a sawtooth, sinusoidal, square, or triangular waveform. The frequency and/or amplitude of the identifying signal may vary with respect to time. For instance, the frequency may progressively increase or decrease with respect to time. The controller 112 is configured to identify the inductive response of the susceptor in reaction to the supply of the identification signal. The controller 112 determines the type of aerosol-generating article 104 from a plurality of aerosol-generating article types, and applies a predetermined heating profile corresponding with the determined type of aerosol-generating article. The predetermined heating profile is selected from a plurality of predetermined heating profiles.

After applying the identification signal, the controller supplies a second electrical signal to the induction coil, which may be described as a heating signal. This heating signal differs from the identification signal at least in terms of its frequency and/or amplitude. In this way, the identification signal can be tailored to suit the task of identifying the aerosol-generating article, while the heating signal can be tailored to optimise heating.

Based on the detection of an authorized article 104, normal operation of the device providing a user experience may be enabled by the controller 112. The controller 112 further comprises a storage of article type specific heating profiles. In dependence on the identity of the inserted article 104, the controller 112 may supply electrical power to the induction coil 108 accruing to the corresponding type-specific heating profile.

The rectangular susceptor 104 shown in FIG. 1 further comprises a specific surface temperature profile. The configuration of the article may be adapted to the surface temperature profile of the susceptor. The susceptor's surface temperature profile is determined, amongst other, by the specific shape of the susceptor. Current may be induced on the surface of the susceptor 110 by the electrical signal supplied to the induction coil. For the rectangular susceptor 110 of the article 104 of FIG. 1, additional eddy currents around the area near the four through-holes are generated leading to a faster increase of the temperature of these areas relative to other areas of the susceptor 110. The configuration of the aerosol-forming substrate, e.g., the spatial distribution of the substrate, may be adapted to the surface temperature profile of the susceptor to provide an optimized user experience.

FIG. 2 shows another embodiment of the aerosol-generating system 100 of the invention. The remarks relating to FIG. 1 above equally apply to the embodiment shown in FIG. 2. However, the device of FIG. 2 further comprises a sensing element comprising a sensing coil 114 and a sensing circuit (not shown). The sensing coil 114 is arranged surrounding the induction coil 108 and the cavity 106 of the device.

The susceptor 110 inductively interacts with the induction coil. The electrical signal of the induction coil adapts in response to such inductive interaction. Such adaption is specific to one or more of the shape, size and material of the susceptor.

The controller monitors the electrical signal of the induction coil using an output of the sensing coil. The output of the sensing coil 114 may be based on a current induced in the sensing coil 114 by the electrical signal supplied to the induction coil.

The controller compares the monitored output of the sensing coil with stored reference data. The controller may correlate the monitored output of the sensing coil with the reference data. Based on such comparison, the controller may identify if the inserted article is an authorized article. Based on such comparison, the controller may identify the type of article inserted.

FIG. 3 shows a further embodiment of the aerosol-generating system 100 of the invention. The explanations relating to FIGS. 1 and 2 above equally apply to the embodiment shown in FIG. 3. However, in FIG. 3, the article 104 includes a different susceptor 110 than the article 104 of FIGS. 1 and 2. In FIG. 3, the susceptor 110 has a parallelogrammatic shape with two zigzag edges. The zigzag edges are parallel to a longitudinal axis of the article 104. The zigzag edges face the induction coil 108 and the sensing coil 114.

The susceptor 110 of FIG. 3 has a different shape than the susceptor 110 of FIGS. 1 and 2. The inductive interaction between the susceptor 110 of FIG. 3 and the induction coil 108 results in a different transient response, frequency response and sensing coil signal output than the inductive interaction between the susceptor 110 of FIGS. 1 and 2 and the induction coil 104. The susceptor 110 of FIGS. 1 and 2 and the susceptor 110 of FIG. 3 each provide a distinct transient response, frequency response and signal output of the sensing coil. The inductive response of the susceptor of FIGS. 1 and 2 is different to the inductive response of the susceptor of FIG. 3

Furthermore, due to the different shapes of the susceptors 110 of FIG. 2 and the susceptor 110 of FIG. 3, the susceptors 110 of FIG. 2 and FIG. 3 provide a different surface temperature profile. The configuration of the aerosol-forming substrate and the shape-specific surface heating profile of the susceptor 110 may complement each other. Variation of the shape of the susceptor 110 allows to adjust the spatial heating profile at and around the susceptor 110.

FIG. 4 shows a further embodiment of the aerosol-generating system 100 of the invention. The remarks relating to FIGS. 1 to 3 above equally apply to the embodiment shown in FIG. 4. However, the susceptor 110 of FIG. 4 has a helical shape. The embodiment of FIG. 4, hence shows a third susceptor shape. The longitudinal axis of the helical susceptor 110 is arranged parallel with a longitudinal axis of the aerosol-generating article 104. In parallel with above discussion to of FIGS. 1 to 3, the helical susceptor of FIG. 4 is a further example of a marker providing a specific surface temperature profile. The inductive response of the susceptor of FIGS. 2 and 3 is different to the inductive response of the susceptor of FIG. 4.

FIG. 5 shows a further embodiment of the aerosol-generating system 100 of the invention. The description relating to FIGS. 1 to 4 above equally apply to the embodiment shown in FIG. 5. However, the article of FIG. 5 is provided with a multitude of susceptors 110. The susceptors 110 are embedded in the aerosol-forming substrate of the article. Each susceptor is of rectangular shape. The lengths of the susceptors 110 varies. The susceptors 110 are smaller than the susceptors 110 of FIGS. 1 to 4. The susceptors are distributed across at least part of the aerosol-forming substrate. The embodiment of FIG. 5 achieves a particularly uniform heating profile across the aerosol-forming substrate.

Each susceptor 110 interacts inductively with the induction coil 108. A specific overall output of the sensing coil, a transient response and a frequency response is generated. As discussed above, based on such specific signal output and responses, the controller 114 may detect the presence of an authorized article 104 and identify the specific article 104 type.

FIG. 6 shows a schematic inductive heating arrangement 116 of the aerosol-generating device. The inductive heating arrangement 116 includes thereby an electric circuitry for generating an alternating high-frequency magnetic field in the cavity of the device via the induction coil 108, and another electric circuity for monitoring an output of the sensing coil 114.

The inductive heating arrangement 116 thereby provides a high frequency alternating current to the induction coil 108, using an amplifier. In the embodiment of FIG. 6, the amplifier is a Class-E power amplifier 122. The inductive heating arrangement 116 incorporates a transistor switch 120 including a Field Effect Transistor (FET) (e.g., a Metal-Oxide-Semiconductor Field Effect Transistor (MOSFET)). The inductive heating arrangement 116 includes a transistor switch supply circuit which is indicated by hollow arrow 118, for supplying a switching signal (gate-source voltage) to the transistor switch 120. The inductive heating arrangement 116 includes the Class E power amplifier 122 including a shunt capacitor 124. The inductive heating arrangement 116 includes a series connection of a capacitor 126 and the induction coil 108, and a sensing circuit 128 optionally including a series connection of capacitor 130 and the sensing coil 114.

An alternating electrical signal is supplied to the induction coil 108 to generate an alternating magnetic field inside the cavity 106 of the aerosol-generating device 102. The sensing coil 114 is configured to detect current variations during the supply of the alternating electrical signal.

The Class E power amplifier incorporates a choke 132. The choke may supply a DC supply current from a DC power source (not shown). The DC power source may be a battery included in the aerosol-generating device 102. Also shown in FIG. 6 is the ohmic resistance 134 modelling the total equivalent resistance or total resistive load 134, which, when the article 104 is present in the cavity 106 of the device 102, is the sum of the ohmic resistance of the induction coil 108 and the ohmic resistance of the susceptor 110, and, if present, the ohmic resistance of the sensing coil 114. Otherwise, in case no article 104 is present in the cavity 106, the equivalent resistance or resistive load 134 only corresponds to the ohmic resistance of the induction coil 108, and, if present, the ohmic resistance of the sensing coil 114.

The change of the total resistive load 134 due to the presence of the susceptor may result in a change of the current supplied to the induction coil 108. Such change may be detected via sensing circuit 128. The alternating magnetic field of the current supplied to the induction coil 108 may induce a current in the sensing coil 114. The current induced in the sensing coil 114 may be indicative of the current supplied to the induction coil 108. When an aerosol-generating article 104 is inserted into the cavity 106 of the aerosol-generating device 102, the presence of the susceptor 110 increases the total resistive load 134. This in turn causes a decrease of the current supplied to the induction coil 108. The decrease of the current supplied to the induction coil 108 is detected by the sensing coil 114. The decrease of the current supplied to the induction coil leads to a corresponding decrease in the current induced in the sensing coil 114.

A controller may be electrically connected with the sensing circuit 128. The controller can monitor and analyse the current induced in the sensing coil or an output of the sensing circuit 128 based on the induced current. Based on the induced current or output based on the induced current, the controller can identify the article 104 or determine the presence or absence of an authorized article 104.

1.-15. (canceled)

16. An aerosol-generating system, comprising:
an aerosol-generating device for a plurality of different aerosol-generating articles,
wherein each one of the plurality of different aerosol-generating articles comprises an aerosol-forming substrate and a susceptor,
wherein each susceptor of each one of the plurality of different aerosol-generating articles differs from the other susceptors of the plurality of different aerosol-generating articles in terms of one or more of susceptor shape, susceptor size, and susceptor material, and
wherein the aerosol-generating device comprises:
a cavity configured to receive one of the plurality of different aerosol-generating articles,
an induction coil configured to heat the susceptor, and
a controller configured to:
supply an electrical signal to the induction coil,
identify an inductive response of the susceptor in reaction to the supply of the electrical signal,
differentiate between the plurality of different aerosol-generating articles based on the inductive response in order to identify the aerosol-generating article received in the cavity, and
identify a transient response, wherein the transient response is a time-domain analysis of a measured output obtained upon the supply of the electrical signal, and wherein the electrical signal is not applied during measurement of the transient response; and
one of the aerosol-generating articles for the aerosol-generating device, wherein a shape, size, and/or material of the susceptor is configured to trigger the inductive response for identification at the aerosol-generating device.

17. The aerosol-generating system according to claim 16, wherein the controller is further configured to identify a frequency response.

18. The aerosol-generating system according to claim 16,
wherein the aerosol-generating device further comprises a sensing element,
wherein the sensing element is configured to detect the inductive response of the susceptor in reaction to the supply of the electrical signal, and
wherein the controller is further configured to identify the inductive response of the susceptor in reaction to the supply of the electrical signal based on a sensing element output.

19. The aerosol-generating system according to claim 18, wherein the sensing element comprises a sensing coil.

20. The aerosol-generating system according to claim 16, wherein the controller is further configured to identify the inductive response of the susceptor in reaction to the supply of the electrical signal based on one or both of an electrical current and an electrical voltage of the supplied electrical signal.

21. The aerosol-generating system according to claim 20, wherein the sensing element is further configured to detect the electrical current of the supplied electrical signal to the induction coil.

22. The aerosol-generating system according to claim 20,
wherein the controller comprises a voltage measurement element,
wherein the controller is further configured to identify the inductive response of the susceptor in reaction to the supplied electrical signal based on an output of the voltage measurement element.

23. The aerosol-generating system according to claim 18, wherein the sensing element is arranged at least partly surrounding the cavity.

24. The aerosol-generating system according to claim 18, wherein the sensing element is arranged fully surrounding the cavity.

25. The aerosol-generating system according to claim 16, wherein the induction coil is arranged at least partly surrounding the cavity.

26. The aerosol-generating system according to claim 16, wherein the induction coil is arranged fully surrounding the cavity.

27. The aerosol-generating system according to claim 16, wherein a shape of susceptor is selected from a rectangular shape with one or more through-holes, a parallelogrammatic shape with at least one undulating edge, and a helical shape.

28. The aerosol-generating system according to claim 16,
wherein the susceptor comprises at least a first portion and a second portion, and
wherein the first portion is made from a different material than the second portion.

29. The aerosol-generating system according to claim 16, wherein the aerosol-generating article comprises at least two susceptors.

30. The aerosol-generating system according to claim 29, wherein each of the at least two susceptors has a rectangular shape.

31. A set comprising at least a first aerosol-generating article for an aerosol-generating device and a second aerosol-generating article for the aerosol-generating device,
wherein the first article comprises an aerosol-forming substrate and at least one susceptor, and wherein a shape, size, and/or material of the at least one susceptor is configured to trigger an inductive response and a transient response for identification at the aerosol-generating device,
wherein the second article comprises an aerosol-forming substrate and at least one susceptor, wherein a shape, size, and/or material of the at least one susceptor is configured to trigger an inductive response and a transient response for identification at the aerosol-generating device, and
wherein the at least one susceptor of the first article is configured to differ from the at least one susceptor of the second article in terms of one or more of susceptor shape, susceptor size, and susceptor material.

32. A method for identifying an aerosol-generating article in an aerosol-generating device of an aerosol-generating system, the method comprising:
providing an aerosol-generating article comprising an aerosol-forming substrate and a susceptor, wherein a shape, size, and/or material of the susceptor is configured to trigger an inductive response for identification at the aerosol-generating device; and
providing the aerosol-generating device comprising a cavity configured to receive the aerosol-generating article, an induction coil configured to heat the susceptor and a controller,
wherein the controller supplies an electrical signal to the induction coil,
wherein the controller identifies the inductive response of the susceptor in reaction to the supply of the electrical signal,
wherein the controller identifies a transient response,
wherein the transient response is a time-domain analysis of a measured output obtained upon the supply of the electrical signal,
wherein the electrical signal is not applied during measurement of the transient response,
wherein the controller identifies a type of the aerosol-generating article based on the transient response, and
wherein the controller identifies the article type by correlating the transient response with pre-stored reference data.
